(19) United States
(12) Patent Application Publication
(10) Pub. No.: US 2026/0247128 A1
(43) Pub. Date: Aug. 20, 2026

(54) METHODS, ARCHITECTURES, APPARATUSES AND SYSTEMS FOR NETWORK-INITIATED WIRELESS TRANSMIT/RECEIVE UNIT REGISTRATION

(71) Applicant: InterDigital Patent Holdings, Inc., Wilmington, DE (US)

(72) Inventors: Taimoor Abbas, Sainte-Julie (CA); Michael Starsinic, Newtown, PA (US); Samir Ferdi, Kirkland (CA); Anuj Sethi, Ottawa (CA); Ulises Olvera-Hernandez, Saint-Lazare (CA); Saad Ahmad, Montreal (CA); Achref Methenni, Montreal (CA); Alec Brusilovsky, Downingtown, PA (US); Michel Roy, Candiac (CA)

(21) Appl. No.: 19/056,266

(22) Filed: Feb. 18, 2025

(51) Int. Cl. H04W 8/00; H04W 52/02; H04W 60/04; H04W 60/06

(52) U.S. Cl. CPC H04W 8/005; H04W 52/0274; H04W 60/04; H04W 60/06

(57) ABSTRACT

Procedures, methods, architectures, apparatuses, systems, devices, and computer program products are provided for network-initiated wireless transmit/receive unit (WTRU) registration. WTRU methods and systems include scanning for and receiving a first system information block (SIB) including network-initiated registration (NIR) information from a wireless network, where the WTRU is not registered with the wireless network and the scanning is based on a scanning configuration. The methods and systems further include transmitting a request for a second SIB to the wireless network based on the NIR information of the first SIB indicating that additional NIR information is available and receiving the second SIB, which includes the additional NIR information. The methods and system additionally include transmitting a registration request to the wireless network based on the NIR information and on the additional NIR information, where the wireless network registers the WTRU based on the registration request.

### TECHNICAL FIELD

The present disclosure is generally directed to the fields of communications, software and encoding, including, for example, to methods, architectures, apparatuses, systems related to registration of a wireless transmit/receive unit with a wireless network.

### BACKGROUND

A wireless network may determine to initiate registration of one or more devices (e.g., wireless transmit/receive units) with the wireless network. Based on the one or more devices being unknown to the wireless network (e.g., not in a particular state, unregistered, or the like), the wireless network may be unable to trigger the one or more devices to request registration with the wireless network.

### SUMMARY

A wireless transmit/receive unit (WTRU) may be powered on and unregistered with a wireless network. For example, the WTRU may be a roaming WTRU without roaming services activated. The wireless network may determine to initiate registration of the WTRU (e.g., for data collection, sensing, or the like). However, the wireless network may be unable to trigger the WTRU (e.g., roaming WTRU) to request registration with the wireless network based on the WTRU being unknown to the network. In accordance with certain embodiments of this disclosure, the WTRU scans for and receives broadcasted SIBs from the wireless network indicating network-initiated registration information for the WTRU to use when transmitting a registration request. In particular, the WTRU receives a first system information block (SIB) (e.g., of a first SIB type) indicating the availability of additional information in a second SIB (e.g., of a second SIB type) and, based on the first SIB, transmits a request for the second SIB (e.g., as part of a system information request). The WTRU then transmits a registration request to the network based on information of the first SIB and/or second SIB. Based on the systems and methods of this disclosure, the wireless network may initiate the registration process for WTRUs that are unknown to the wireless network and/or not within a particular connection management (CM) state (e.g., CM_Connected state, CM_Idle state, or the like).

In accordance with certain embodiments of the present disclosure, methods and systems are provided for operating a WTRU. A method includes determining to scan for a first SIB of a first SIB type based on a scanning configuration, where the WTRU is not registered with a mobile network operator (MNO) of a wireless network and the scanning configuration includes at least one of a time period for scanning, a time window for scanning, a frequency band for scanning, or a radio access technology (RAT) for scanning. The method further includes receiving, based on determining to scan, the first SIB from the wireless network, where the first SIB includes network-initiated registration (NIR) information indicating whether additional NIR information is available. The method additionally includes transmitting, based on the NIR information indicating that the additional NIR information is available, a request for a second SIB of a second SIB type to the wireless network, where the second SIB includes the additional NIR information. The method also includes receiving the second SIB from the wireless network based on the request. The method further includes transmitting a registration request to the wireless network based on the NIR information and on the additional NIR information, where the MNO of the wireless network registers the WTRU based on the registration request.

In some embodiments, the method even further includes determining to enter a deep-sleep state and transmitting (e.g., based on determining to enter the deep-sleep state) a deregistration request to the wireless network. In some embodiments, the deregistration request includes an indication that the WTRU has entered the deep-sleep state. In some embodiments, the additional NIR information includes a randomization parameter, the method additionally includes determining a random delay based on the randomization parameter, and transmitting the registration request to the wireless network is based on the random delay.

In some embodiments, determining to scan for the first SIB is based on at least one of: detecting a local condition of the WTRU (e.g., an environmental condition, an indication from a paired device, or the like); detecting a user (e.g., GUI application) interaction with the WTRU; combinations of the same; or the like. In some embodiments, the first SIB type is SIBtype1 and the second SIB type is SIBtypex (e.g., where x is an integer greater than or equal to 2). In some embodiments, the scanning configuration is received from the wireless network or is an existing configuration of the WTRU. In some embodiments, at least one of the NIR information or the additional NIR information further includes at least one of: a registration type; a device type; an indication for new devices to register; an indication for previously registered devices to register; registration grouping information or clustering information; a randomization parameter for registration initiation; or request-specific trigger parameters or service-specific trigger parameters.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a system diagram depicting an illustrative 5G network architecture, in accordance with certain embodiments;

FIG. 3 is a system diagram depicting an illustrative control plane stack between a WTRU and an access and mobility management function (AMF), in accordance with certain embodiments;

FIG. 4 is a system diagram depicting am illustrative next generation network architecture with RAN as the service-based interface (SBI) gateway, in accordance with certain embodiments;

FIG. 5 is a diagram depicting an illustrative system information block (SIB) broadcast-based network-initiated registration (NIR) approach, in accordance with certain embodiments;

FIG. 6 is a flowchart of illustrative steps for performing a NIR of a WTRU in deep-sleep, in accordance with certain embodiments; and

FIG. 7 is a flowchart of illustrative steps for performing a NIR, in accordance with certain embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

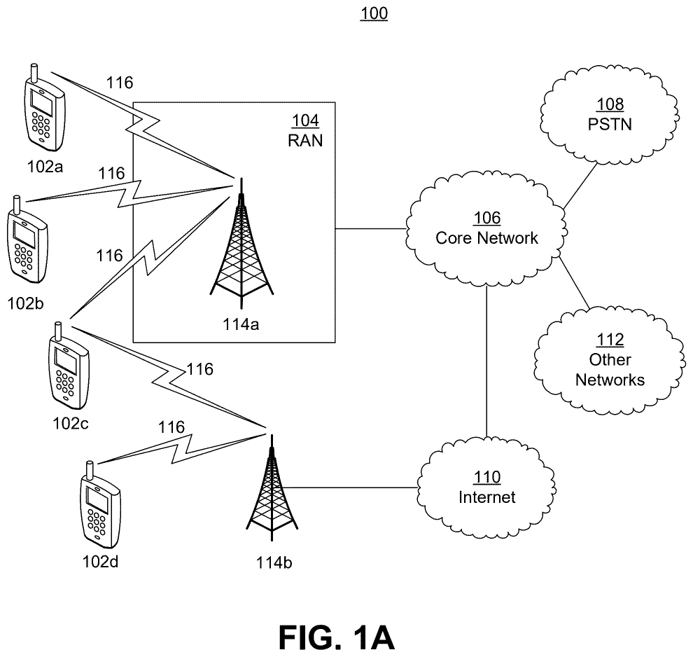

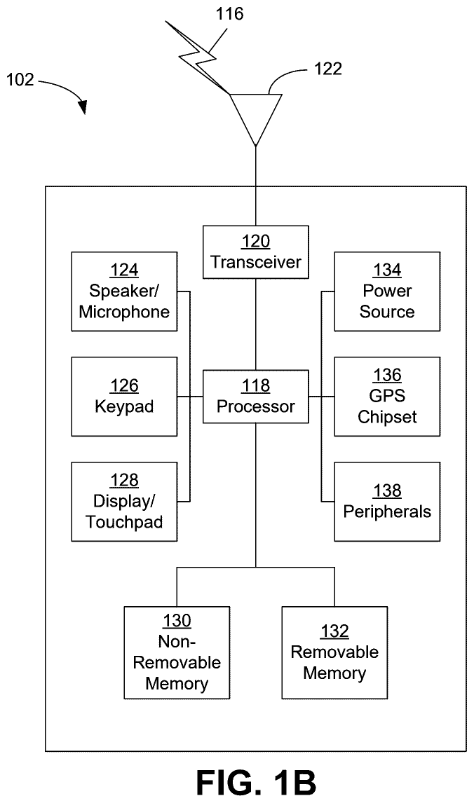

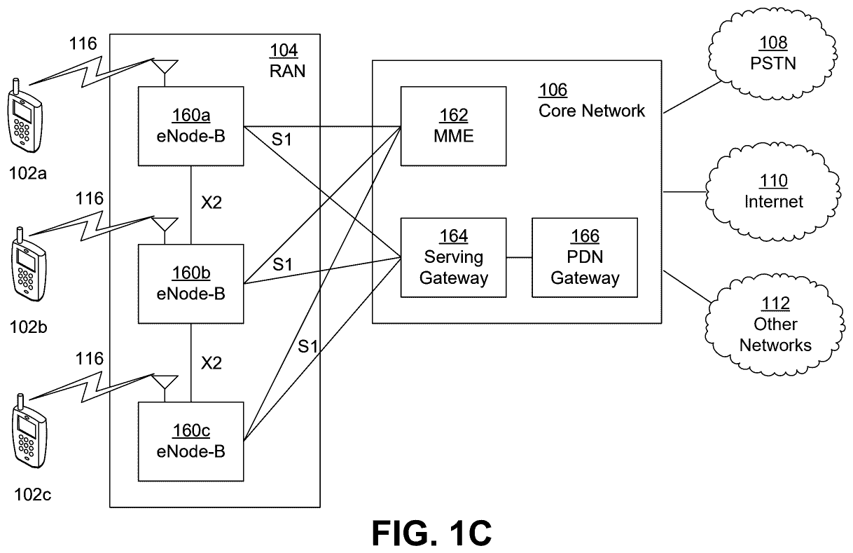

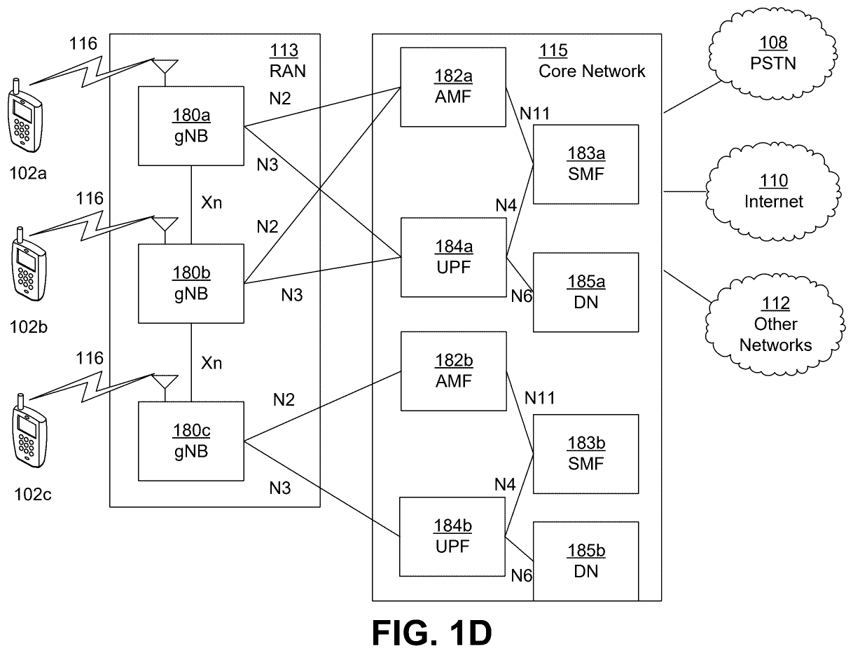

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a next generation gNode-B (ng-gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

It will be understood that a wireless network may include any suitable components and devices, including, for example, any of one or more base stations, one or more TRPs, one or more gNBs, one or more WTRUs, any other suitable device or component, or any combination thereof. It will be further understood that a component or device that is part of the wireless network can be referred to as communicating with the wireless network when it is communicating with any one or more other components or devices of the wireless network. For example, reference to a WTRU, which is part of the wireless network, transmitting or receiving signals to or from the wireless network refers to the WTRU transmitting or receiving signals, respectively, to or from any other component or device (e.g., another WTRU) of the wireless network.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, orthogonal frequency division multiplexing (OFDM) symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

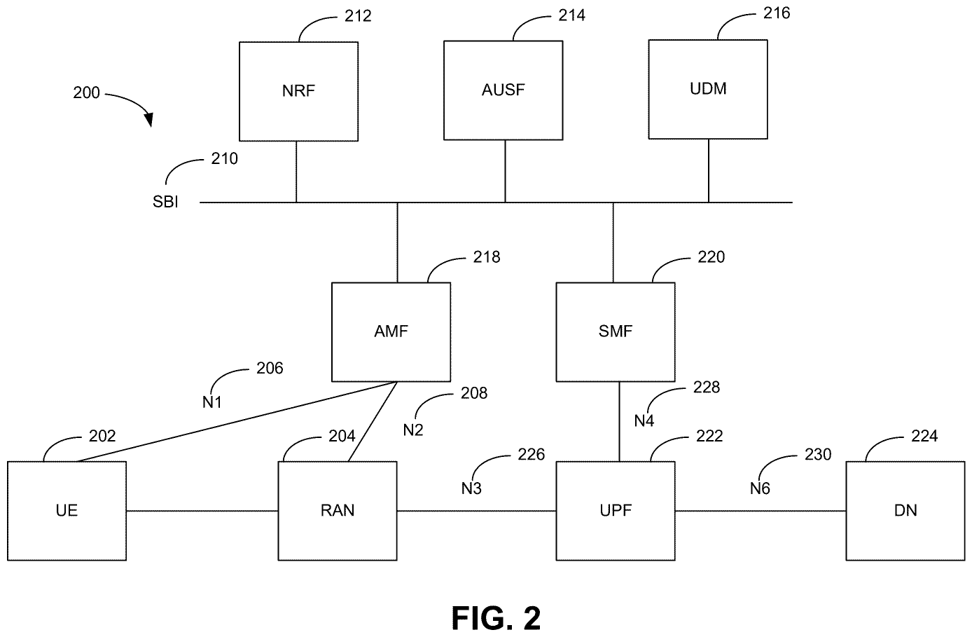

In certain embodiments of the present disclosure, including those described below at least in connection with FIGS. 2-7, the devices, systems, architectures, communication links, apparatuses, and other elements depicted in FIGS. 1A-1D may be used in connection with network-initiated registration of WTRUs.

The evolution of 5G network architecture may enable new capabilities of both the WTRU and the wireless network. Some of the existing procedures associated with the WTRU and the wireless network may be enhanced or redefined to enable the next generation of mobile communication systems.

FIG. 2 is a system diagram depicting 5G network architecture, in connection with certain embodiments.

As shown in FIG. 2, in 5G network architecture a service-based architecture (SBA) 200 may be implemented. For example, within the SBA, network functions (NFs) communicate with each other using a service-based interface (SBI) 210 (e.g., using protocols like HTTP). For example, NFs may include at least one of the following: access and mobility management function (AMF) 218, session management function (SMF) 220, unified data management (UDM) 216, combinations of the same, or the like. The SBA may be implemented to enable NFs to expose services providing NF functionality (e.g., using Representational State Transfer Application Programming Interfaces (RESTful APIs)) to other NFs. Further, for example, the SBA may include at least one of the following components: network repository function (NRF) 212, authentication server function (AUSF) 213, user plane function (UPF) 222, data network (DN) 224, combinations of the same, or the like.

In some approaches (e.g., 5G network architecture approaches), a full service-based environment is not offered. Some interfaces (e.g., N1 206, N2 208, N3 226, N4 228, and N6 230) may remain exclusively as point-to-point interfaces between two entities and do not operate over the SBI. For example, the WTRU 202 may communicate with AMF 218 over the N1 206 interface using a non-access stratum (NAS) protocol. Control plane messaging between the WTRU 202 and the other NFs (e.g., SMF 220) may be performed using a NAS transport encapsulation mechanism provided by the AMF 218 to the NFs. Further, for example, the RAN 204 may communicate with AMF 218 over N2 208. Moreover, for example, the RAN 204 may communicate with UPF 222 over N3 226. Additionally, for example, the UPF 222 may communicate with SMF 220 over N4 228. Also, for example, the UPF 222 may communicate with DN 224 over N6 230.

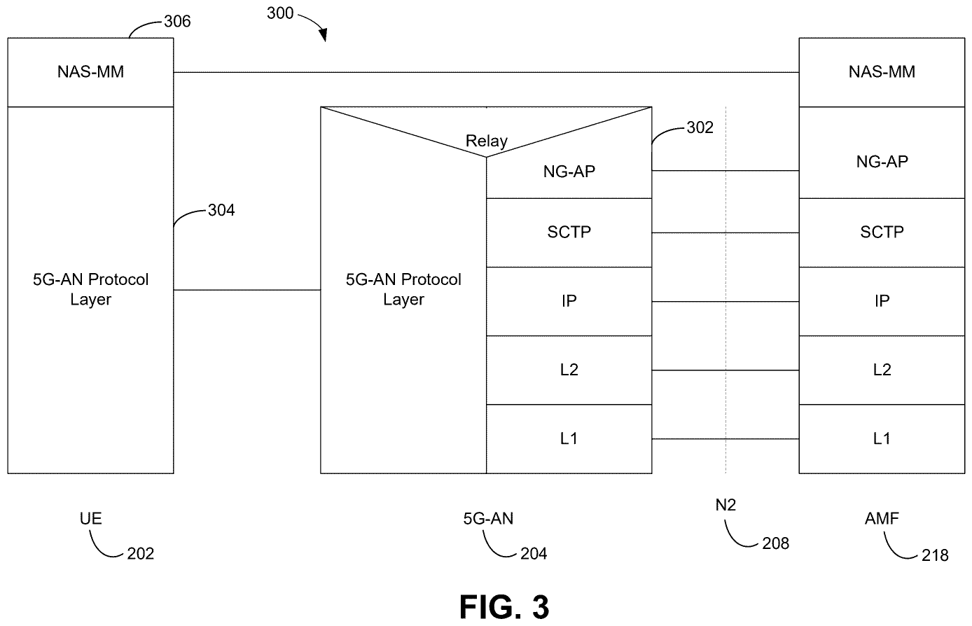

FIG. 3 is a system diagram depicting a control plane stack between a WTRU and an AMF, in accordance with certain embodiments.

In some approaches (e.g., 5G network architecture approaches), a control plane stack 300 may be implemented between the WTRU 202 and AMF 218. For example, as shown in FIG. 2, the RAN 204 may communicate with the AMF 218 over N2 208 using next generation application protocol (NGAP) 302. Further, for example, control plane messaging between the WTRU 202 and a RAN 204 (e.g., access stratum (AS) of RAN 204) may be achieved using radio resource control (e.g., in the top layers of the 5G-AN protocol layers 304). Moreover, for example, the control plane messaging may be used to transport NAS messages received or sent by the RAN 204 over N2 208 (e.g., via NAS mobility management (NAS-MM) 306).

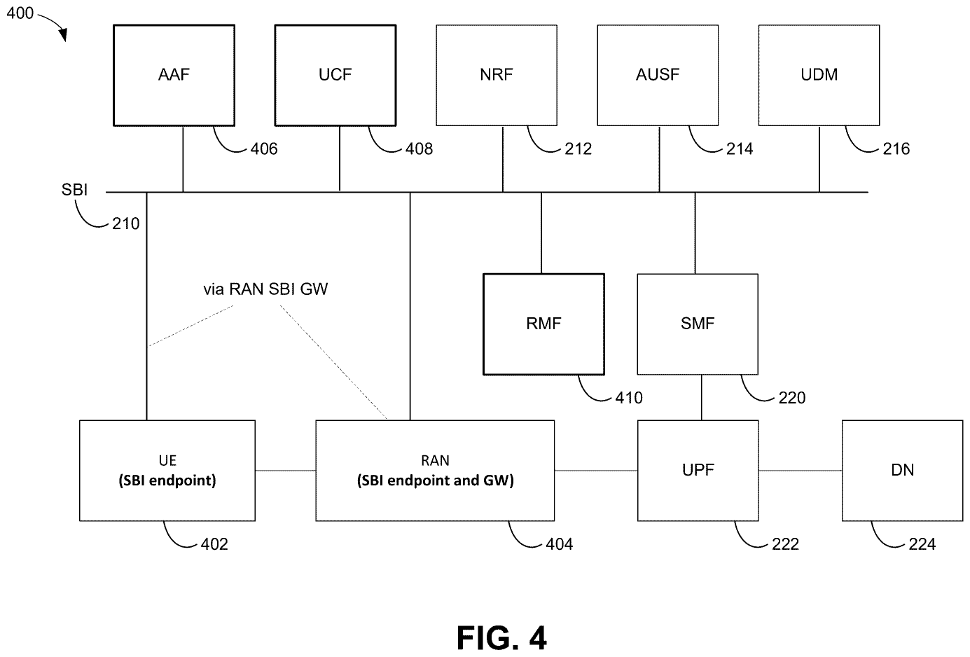

FIG. 4 is a system diagram depicting a next generation network architecture with RAN as the SBI gateway, in accordance with certain embodiments.

As shown in FIG. 4, next generation network architecture 400 may extend SBA concepts to the RAN, simplifying the network architecture while also taking advantage of cloud native and micro-service technologies to enhance architecture capabilities such as scalability, elasticity, and open interfaces.

Some approaches may extend the SBI framework beyond the 5G core network NFs. For example, a WTRU 402 may use an evolved NAS mechanism to exchange NAS application messages directly with one or more NFs. Further, for example, an SBI-compliant WTRU may establish an NAS application layer communication directly with an NF (e.g., SMF 220) without going through AMF 218 (e.g., by enhancing the N1 206 reference point to offer NAS application services over an SBI 210).

Such approaches may assist in achieving “connected intelligence”, where intelligent networks using artificial intelligence/machine learning (AI/ML) technology will be able to connect a multitude of “intelligent” things. The quantity of data collected from the connected devices (e.g., sensors, ambient internet of things (IoT) devices, or the like) and the added flexibility and adaptability of AI/ML-enabled functionalities, may allow such systems and architectures (e.g., next generation network architecture 400) to enable new advanced applications such as XR/Metaverse.

For example, the next generation architecture 400 may include new functionalities including at least one of the following: WTRU 402 acting as a SBI endpoint, RAN 404 acting as an SBI endpoint and gateway (GW), authentication and authorization function (AAF) 406, UE context management function (UCF) 408, registration and mobility management function (RMF) 410, combinations of the same, or the like.

For example, the RAN node 404 may support SBI for the next generation core network (nCN). Herein, RAN node (e.g., for 6G), ng-gNB, and intelligent Node-B (iNB) may be referred to interchangeably. Further, for example, the iNB 404 may directly invoke the necessary services based on the procedure being performed with the WTRU 402. Moreover, for example, once the WTRU 402 is successfully identified and authenticated, the iNB may invoke the service of a UCF 408. Also, for example, the UCF 408 may act as a “representative” of the WTRU 402 in the nCN. Accordingly, the UCF 408 may maintain (e.g., any) stateful information related to the WTRU 402 including at least one of the following: registration/connection states; location; security context (e.g., key material for SBI level security and AS security); subscription data from UDM 216; session management information (e.g., protocol data unit (PDU) session contexts); combinations of the same; or the like. In such examples, the UCF 408 provides the “WTRU context as a service” to other NFs in the nCN.

For example, the iNB 404 may invoke the service of a RMF 410 for access control or mobility updates of the WTRU 402. The RMF 410 may rely on another NF (e.g., UCF 408) for stateful information maintenance, and there may not exist a tight coupled connection between the iNB 404 and RMF 410 (e.g., unlike the connection between gNB and AMF 218).

For example, the iNB 404 may invoke the SMF 220 for session management service. The SMF 220 may be an evolved version of the 5G SMF to support direct interaction with iNB 404 for actions including user plane resource allocation and/or access node (AN)-core node (CN) tunnel establishment. Further, for example, direct communication between the iNB 404 and SMF 220 allows for a reduction of SBI overhead due to messaging with an intermediate NF (e.g., AMF 218) compared to 5G.

In some system design approaches, when a WTRU 402 is powered on, the WTRU 402 performs a registration request procedure automatically. For example, the wireless network may wait for the WTRU 402 to act (e.g., waiting for the WTRU 402 to send the registration request), and initiates registration or a registration update request only when the WTRU 402 is somehow known to the wireless network. Further, for example, the WTRU 402 may become known to the wireless network when the wireless network has context and the WTRU 402 is in one of a CM_CONNECTED or CM_IDLE state. Accordingly, network-initiated registration (NIR) may be desired.

Some approaches to NIR and mobility procedures may be limited by the assumption that the WTRU can receive paging or a downlink NAS transport (e.g., the WTRU is present in CM_Connected or CM_Idle mode) to support WTRU context update or re-registration. Introducing the new services and architectural enhancements proposed in 6G may require network-initiated registration request (NIRR) procedures for WTRUs that are not registered or known to the wireless network (e.g., or WTRUs that are in a special state other than CM_Connected or CM_Idle mode).

In accordance with certain embodiments of the present disclosure, use cases for NIR are described as follows.

For example, the WTRU may be unknown to the wireless network. Further, for example, the WTRU may be powered on but has not registered to the wireless network. In this example, the wireless network may be unaware of the WTRU and may want to trigger the WTRU to initiate registration.

For example, the wireless network may perform registration management of a bulk of WTRUs in an area (e.g., geographic area). Further, for example, thousands of WTRUs may be powered on in a short span of time in a geographical area (e.g., for artificial intelligence of things (AIoT) devices, sensing devices, drones, combinations of the same, or the like) and the WTRUs may not have registered with the wireless network. In such examples, the wireless network may not want all the WTRUs to trigger registration at once and NIR may increase the level of control of the wireless network over the registration process for all the WTRUs.

For example, the wireless network may desire registration of a roaming WTRU. Further, for example, one or more WTRUs (e.g., roaming WTRUs that do not want to pay for roaming services) in the vicinity of a wireless network may not have registered to the wireless network. Moreover, for example, the wireless network may desire to obtain (e.g., registration of) roaming WTRUs for some applications and may trigger NIR. Also, for example, such applications may include at least one of AI/ML model data collection, sensing, or the like.

For example, the wireless network may desire registration of WTRUs under disaster roaming. Further, for example, a public land mobile network (PLMN) (e.g., PLMN D) may experience a disaster condition and the WTRUs initially served by the PLMN (e.g., PLMN D) may have moved to a different PLMN that is not under disaster and can provide disaster roaming (e.g., PLMN A). Moreover, for example, when the disaster condition is over, the PLMN (e.g., PLMN D) may desire for the WTRUs to return and may request the WTRU to trigger registration with the original PLMN (e.g., and stop roaming on PLMN A).

For example, a WTRU may have deregistered and entered a deep-sleep or retired mode. Further, for example, the WTRU may have entered the deep-sleep mode to save power (e.g., and may not desire to stay registered on the network or stay in a CM_Idle mode). In such examples, based on a mutual agreement between the wireless network and the WTRU, the WTRU may retire but remain available to be awaken when required by the wireless network (e.g., for downlink data transfer, AI/ML model data collection, or the like). The WTRU may trigger the WTRU for registration in such examples.

In some cellular systems design approaches, the registration request procedure is a procedure initiated by the WTRU automatically or according to a specific non-standardized implementation, as soon as it is powered on, based on expiration of a timer entry of the WTRU into a new registration area. In such approaches, the registration request procedure is necessary to enable other network operations including authentication/authorization, mobility management, roaming, and/or power optimization.

In some approaches network-initiated (e.g., or network-triggered) registration may be supported with the limitation that the WTRU is already registered and in a CM_Connected or CM_Idle mode. In such approaches, the wireless network may trigger registration (e.g., re-registration, based on a WTRU configuration update procedure).

Some cellular systems approaches do not, however, support NIR procedures for initial registration (e.g., for WTRUs that are in a deregistered and/or unregistered state). In such approaches, the wireless network cannot trigger registration if the WTRU has never registered and/or has no context in the wireless network. For example, the wireless network may have no means to trigger registration for a WTRU that has just powered on but does not initiate the registration procedure on its own.

For future cellular systems (e.g., in 6G and beyond) a wireless network may desire to trigger the WTRUs to request registration with the wireless network even when the WTRUs are unknown to the network. Thus, a solution is desired that determines at least one of the following: when to initiate NIR, how to initiate NIR with WTRUs unknown to a wireless network, how to initiate NIR with WTRUs that are known to a wireless network. Accordingly, systems and methods (e.g., including functions and information flows) for enabling NIR of WTRUs for next generation mobile systems are described herein.

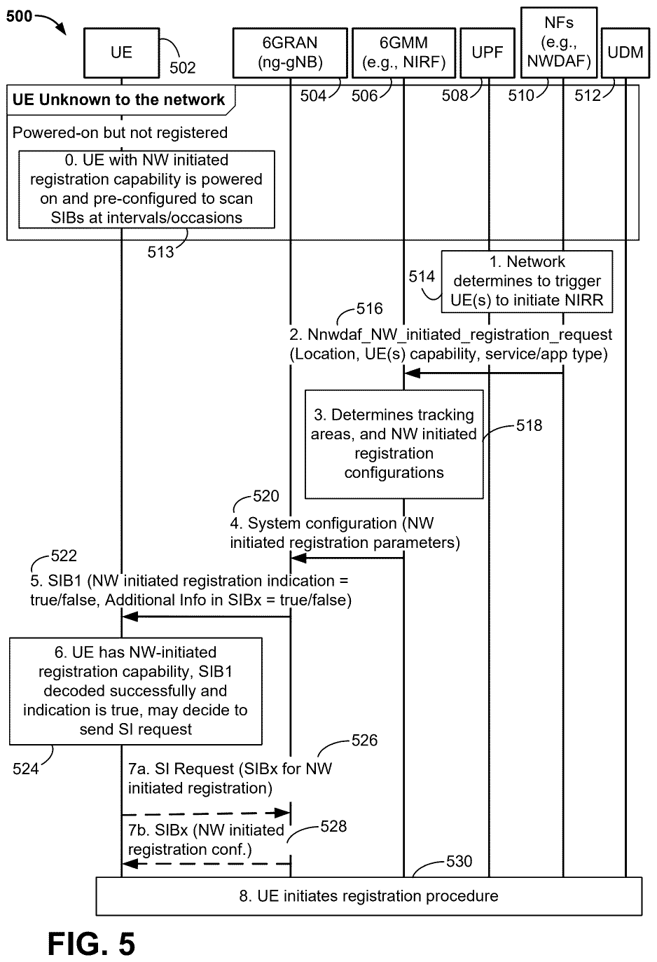

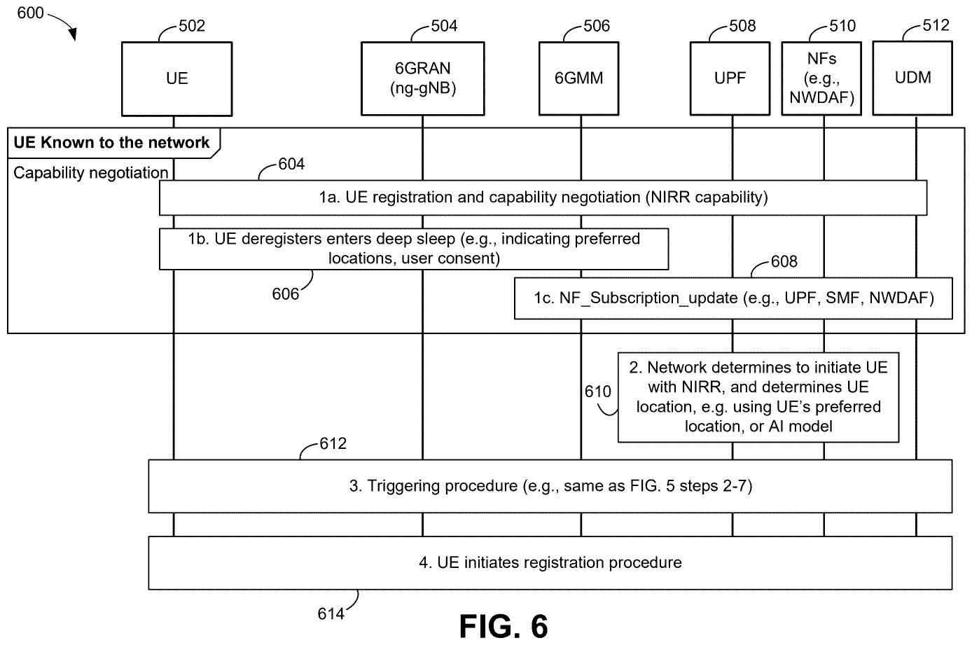

In accordance with certain embodiments of the present disclosure, systems and methods for WTRUs (e.g., WTRU 102 of FIGS. 1A-D, WTRU 202 of FIGS. 2-3, WTRU 402 of FIG. 4, WTRU 502 of FIGS. 5-6) that are unknown to a wireless network (e.g., core network 106 and 115 of FIGS. 1A-D, RAN 104 and 113 of FIGS. 1A-D) to participate in NIR via a System Information Block (SIB) based indication described as follows. For example, such WTRUs may be powered-on (e.g., and present in cell coverage) and may not immediately initiate a registration request but rather determine to listen (e.g., scan) for a broadcasted SIB. Further, for example, such WTRUs may only send a registration request when they are instructed by the wireless network. Moreover, for example, such systems and methods may be enhanced to enable NIR for a device known to the wireless network in a deep-sleep or retired state.

In certain representative embodiments, the WTRU may be associated with at least one of the following pre-conditions prior to receiving the broadcasted SIB: the WTRU is powered on but not registered with the wireless network; the WTRU has NIR capability; the WTRU is configured (e.g., pre-configured) with parameters for when to perform cell selection and scan for the SIB (e.g., or master information block (MIB)); the WTRU is triggered by a graphical user interface (GUI) application in the terminal equipment (TE) of the WTRU to start scanning for the SIB (e.g., or MIB); combinations of the same; or the like.

For example, the WTRU may be configured (e.g., with the parameters for cell selection and SIB/MIB scanning) in a universal subscriber identity module (e.g., USIM) and/or management terminal (MT). Further, for example, the WTRU may have received a configuration (e.g., with the parameters for cell selection and SIB/MIB scanning) during a previous registration as part of a UE parameters update (UPU) or UE configuration update (UCU) procedure.

In certain representative embodiments, the WTRU may perform the following actions associated with receiving a SIB broadcast indicating an NIR: scanning for SIB1 (e.g., of type SIBtype1); receiving SIB1 from a wireless network (e.g., including a NIR indication and/or additional information indication); decoding SIB1 and determining that the NIR indication is true and determining to request for SIBx based on the additional information indication; sending a system information (SI) request to the wireless network (e.g., next generation gNB (ng-gNB)), which indicates the requested SIBx ID; receiving the SIBx from the wireless network (e.g., ng-gNB); determining to initiate registration with the wireless network (e.g., ng-gNB); combinations of the same; or the like.

For example, the NIR indication may have a true or false value, corresponding to on or off, respectively.

For example, the additional indication may have a true or false value and indicate whether additional information is available for NIR-capable WTRUs in a SIBx (e.g., of type SIBtypex, wherein x may be between 2 and 21, including 2 and 21).

For example, the WTRU may receive a SIBx from the ng-gNB carrying NIR-specific information for the WTRU. Further, for example, such NIR-specific information may include at least one of the following: a registration request type; an indication for any new device to register; an indication for the devices which have previously registered within a certain time period to register; registration request group information and/or clustering information (e.g., device type, device capabilities, service type, group identifier, or the like); randomization parameter to randomize the initiation of registration request; service-specific trigger parameters (e.g., sensing-capable WTRUs to report sensed data); combinations of the same; or the like.

In certain representative embodiments, the WTRU performs at least one of the following actions in association with NIR for a WTRU in deep-sleep: registering with the network (e.g., with a valid subscription and NIR capability); performing capability negotiations during the initial registration or registration update and indicating that the WTRU supports NIR capability; determining to enter a deep-sleep state (e.g., retired state); sending a deregistration request (e.g., including a deep-sleep indication); any of the WTRU actions in association with receiving a SIB broadcast indicating an NIR; combinations of the same; or the like.

For example, the deregistration request may include a container that contains a list of preferred locations (e.g., including most recent or most often used cell IDs) and/or user consent that allows the wireless network to keep user data (e.g., associated with the WTRU) for a time period indicated in the consent.

In some embodiments, it is assumed that the WTRU has NIR capability and therefore, when the WTRU powers on, the WTRU does not automatically initiate a registration request procedure.

In some embodiments, the WTRU has never been registered with the wireless network before and the wireless network has no information or context of the WTRU. In such embodiments, for the wireless network to reach WTRUs with such capabilities, the network trigger request may be based on coarse-grained information about the areas in which to reach such WTRUs. For example, the wireless network may determine to trigger registration for any WTRU present in certain locations (e.g., supporting a specific service or application). Further, for example, the network-initiated trigger may have additional information for different WTRUs with NIR capabilities.

The network-initiated trigger may provide several benefits. For example, thousands of IoT devices or sensors may be deployed in an area and a wireless network may trigger a NIR procedure to achieve smooth onboarding and/or ordered access of these devices to the wireless network, without overloading the wireless network. In such examples, by triggering the procedure from the wireless network, an operator may obtain better control of the procedure (e.g., by clustering devices by location and/or functionality). Further, for example, the wireless network may allow certain cluster of devices in a location to register with the wireless network first, which is then followed by registration of subsequent clusters of devices.

FIG. 5 is a flow diagram depicting a SIB broadcast-based NIR approach, in accordance with certain embodiments.

As shown in process 500 of FIG. 5, in certain representative embodiments, the WTRU 502 (e.g., at step 0 513) is powered on, has NIR capability, and is pre-configured with intervals and/or occasions for scanning to obtain a MIB and/or SIB (e.g., from a gNB). For example, the pre-configuration may include at least one of the following: time periods for scanning; a specific time window for scanning; a time instance for scanning; frequency bands for scanning; radio access technology (RAT) for scanning; combinations of the same; or the like. Further, for example, the pre-configuration may be used to scan for a MIB and/or SIB for NIR. Moreover, for example, the WTRU 502 may be configured (e.g., after a previous registration) using a UPU or UCU. Also, for example, based on a configured timer, the WTRU 502 may decide to perform cell selection and camp on cell to receive system information from the RAN node.

In some embodiments, a GUI application runs in the TE part of the WTRU 502. For example, the GUI may present the user of the WTRU 502 with a button or icon that can be pressed by the user to trigger the WTRU 502 to begin scanning (e.g., reading) for a MIB and/or SIB. Further, for example, the press from the user may trigger the GUI to invoke an application programming interface (API) (e.g., an attention (AT) command of the mobile termination (MT) component of the WTRU 502). Also, for example, the API may trigger the MT part of the WTRU 502 to begin scanning (e.g., for a SIB and/or MIB). Additionally, for example, the GUI may label the button “search for the network”.

In some embodiments, the WTRU 502 is configured to begin scanning (e.g., for a SIB and/or MIB) when it detects local conditions. For example, local conditions may refer to detecting environmental conditions (e.g., vibrations, heat, or the like) and/or receiving an indication from a paired device via a connection (e.g., a Bluetooth connection). Further, for example, the WTRU 502 may have sensing capabilities and one of the sensors may internally indicate data to be sent (e.g., to the wireless network). Also, for example, the WTRU 502 may wait for the network to initiate the registration process, may start to scan for a SIB (e.g., or MIB), and may not initiate the registration process on its own.

In certain representative embodiments, the wireless network (e.g., UPF 508 and/or NFs 510 at step 1 514) determines to trigger the WTRU 502 (e.g., one or more WTRUs) for NIR. Herein, wireless network may refer to one or all the NFs in the core network (e.g., network data analytics function (NWDAF) 510, UPF 508, 6G mobility management (6GMM)/network-initiated registration management function (NIRF) 506, UCF, or the like). In some embodiments, the determination is done by the core network. In some embodiments, the determination is done in coordination between the core network and the application function (AF). For example, the wireless network may determine to trigger the WTRU 502 based on at least one of the following criteria: the wireless network determining to perform inventory collection of WTRUs in a certain (e.g., geographic) area; the wireless network determining to obtain roaming WTRUs in a certain (e.g., geographic) area; the wireless network determining to obtain WTRUs associated with a disaster condition; the wireless network determining that the network load in an area of interest has become low or acceptable; combinations of the same; or the like.

For example, the wireless network may determine to perform inventory collection of the WTRUs in a certain (e.g., geographic) area (e.g., to make sure that the WTRU 502 is still present for an AI/ML model for network analytics). Further, for example, the wireless network may transmit a request to trigger WTRUs to initiate registration (e.g., for status and location reporting). Moreover, for example, the wireless network may periodically send a NIR request indication in the SIB to trigger the WTRUs to initiate the registration request.

For example, the wireless network may determine to obtain roaming WTRUs in an area and may trigger the WTRUs to indicate that the wireless network is available, and registration requests may be initiated by the roaming WTRUs.

For example, the wireless network may have recovered from a disaster condition and may determine to obtain the WTRUs associated with the disaster condition (e.g., returning the WTRUs to their regular serving networks).

For example, the wireless network may determine to initiate registration for some WTRUs but may determine that the network load in a certain area was high. Further, for example, the wireless network may determine to not initiate registration for such WTRUs. Moreover, for example, the wireless network may determine that the network load in the certain area has become low and/or acceptable and may perform the network-initiated WTRU registration.

In certain representative embodiments, a NF 510 (e.g., NWDAF) triggers a NIRR (e.g., Nnwdaf_NW_initiated_registration_request 516) directed to 6GMM NFs 506 (e.g., NIRF, policy control function (PCF), or the like). For example, the NIRR may include at least one of the following: a location of interest; a list of WTRU capabilities with at least one capability (e.g., NIRR capability) and applications/service types.

In some embodiments, the NIRF 506 is an NF located in the core network to support NIR-related requests and queries. For example, an AF may interact with the NIRF via a network exposure function (NEF) or may directly direct a WTRU 502 in an area to register with the wireless network. Further, for example, the AF may provide input location info including geographical area and/or network area (e.g., tracking area, cell info, or the like). Moreover, for example, the AF may provide the WTRU 502 external IDs with which the WTRU 502 is authorized to request NIR for the corresponding WTRUs. Additionally, for example, the AF may provide a preferred or expected time window for the NIR to occur (e.g., a time window to avoid performing NIR).

In some embodiments, the NIRF 506 selects the NF (e.g., AMF, 6GMM or RAN node 504) that is appropriate to wake up the devices (e.g., WTRUs) based on location information and using NIR. In some embodiments, the NIRF 506 determines the last known location from a WTRU external ID (e.g., stored in UDM 512 and/or unified data repository (UDR) from a last registration).

In some embodiments, the broadcast signal (e.g., in the SIB) from RAN 504 triggers the registration of the WTRUs in the target area. For example, the NIRF 506 and/or NEF may filter the WTRUs based on matching external IDs provided by AF (e.g., to only expose the WTRU 502 presence/location to an authorized AF). Further, for example, filtering may be based on information provided by the WTRU 502 when registering (e.g., via application or service ID in the registration request). Additionally, for example, the AF may use the information about the WTRU registration status from NEF and/or NIRF 506 for subsequent communications. Moreover, for example, the AF may use the knowledge of WTRU registration status to send downlink (DL) user plane (UP) data (e.g., after connection is established with the WTRUs), for DL messaging over the control plane, or for short message service (SMS) over NAS.

In certain representative embodiments, the NIRF 506 (e.g., at step 3 518) receives the NIRR (e.g., Nnwdaf_NW_initiated_registration_request 516) and interacts with other NFs (e.g., tracking and reachability function (TRF), PCF, or UDM 512) to determine SIB parameters (e.g., for SIB configurations in the ng-gNB 504). In some embodiments, the NIRF 506 also determines applicable tracking areas based on the location (e.g., of the WTRU 502) for ng-gNB selection (e.g., of the ng-gNBs that would broadcast the SIB for NIR). For example, SIB parameters may include at least one of the following: a broadcast PLMN list, a tracking area identity (TAI), paging info, cell access info, SIB scheduling info, SIBx-related info (e.g., where SIBx carries NIR-related information), combinations of the same, or the like.

In some embodiments, the NIRF 506 receives the SIB parameters from an operation and maintenance platform (O&M) via NEF. For example, the O&M may work alongside the PCF, NIRF, or equivalent function to determine and provide configurations for NIRR SIB configurations. In such examples, the PCF may not necessarily be associated with a specific WTRU 502 and may instead be associated with a group or class of WTRUs subject to a similar policy. Further, for example, the NIRF 506 may use NWDAF 510 services to predict a likely location of group of WTRUs based on application information including an application ID and/or a last known location pattern.

In certain representative embodiments, the NIRF 506 sends a system information configuration request 520 to ng-gNB 504 (e.g., NIRF_system_info_config_request) by including the SIB parameters. In some embodiments, the system information configuration request 520 is sent using NGAP over a 5G control plane interface. In some embodiments, the system information configuration request 520 is sent over the SBI (e.g., SBI 210 of FIG. 4) to ng-gNB 504.

In certain representative embodiments, the ng-gNB 504, based on the SIB parameters, generates the SIB1 522 and SIBx 528 messages. In some embodiments, the ng-gNB 504 only broadcasts SIB1 522 and includes an NIR indication set to true or false (e.g., corresponding to on or off, respectively). In some embodiments, SIB1 522 includes an additional information indication set to true or false to indicate whether there is additional information available for NIR-capable WTRUs (e.g., and the ability to request for SIBx if the WTRU 502 is interested).

In certain representative embodiments, the WTRU 502 (e.g., at step 6 524) scans for and receives the SIB1 522. For example, the WTRU 502 may have NIR capability scans for a MID and/or the SIB1 based on pre-configurations. In some embodiments, the WTRU 502 decodes the received SIB1 522 and determines that the NIR indication is set to true, and the additional information indication is set to true. In such embodiments, the WTRU 502 may determine to request for a SIBx 528 (e.g., of type SIBtype2 through SIBtype21).

In some embodiments, the entire SIB (e.g., SIB1 522 or SIBx 528) and/or its components may be protected for integrity, confidentiality, and/or replay using at least one of the following: a pre-shared security association; public-key cryptography (e.g., where a gNB public key is known to the WTRU 502 and the SIB and/or its components are protected by a private key known to the gNb 504); freshness parameters (e.g., timestamp, counter, or the like); combinations of the same; or the like.

In certain representative embodiments, the WTRU 502 sends a SI request 526 to the ng-gNB 504 (e.g., based on the received SIB1). In some embodiments, the SI request indicates a SIBx ID.

In certain representative embodiments, the ng-gNB 504 sends the SIBx 528 to the WTRU 502. For, example, the SIBx 528 may carry NIR-specific information for the WTRU 502. Further, for example, the SIBx 528 may include at least one of the following: a registration request type; registration request group information and/or clustering information (e.g., based on capabilities); a randomization parameter to randomize the initiation of registration requests (e.g., to prevent simultaneous registration of all WTRUs); combinations of the same; or the like.

In some embodiments, the ng-gNB 504 determines a threshold (e.g., maximum) number of simultaneous NIR procedures to take place at a certain time and in a certain area. For example, the ng-gNB 504 may have received this information from the core network. Further, for example, the ng-gNB 504 may keep a counter to account for the number of NIR requests that it has received during a particular time window. Moreover, for example, the ng-gNB 504 may track the number of successful registrations (e.g., NIRs) that took place at the area of interest. Such counters may help the RAN 504 determine how many WTRUs to send the SIBx 528 or NIR instruction. Also, for example, such counters may help the RAN 504 set up timers or randomizers for efficient scheduling of received registration requests.

In accordance with certain embodiments of the present disclosure, information carried by a SIB (e.g., SIBx 528 or SIB1 522) related to NIR are described as follows.

For example, the SIB may include an indication that the wireless network wants any device (e.g., WTRU) that has not been previously registered to the wireless network to register to the wireless network.

For example, the SIB may include an indication that the wireless network wants any device (e.g., WTRU) that has previously been registered to the wireless network to register to the wireless network.

For example, the SIB may include an indication (e.g., with a time period) that the wireless network wants any device (e.g., WTRU) that has previously been registered to the wireless network within the time period to register to the wireless network.

For example, the SIB may include an indication (e.g., with a time period) that the wireless network wants any device (e.g., WTRU) that has not been previously registered to the wireless network within a period to register to the wireless network.

For example, the SIB may include a device type (e.g., ambient IoT devices, devices with sensing capabilities) to the wireless network to register to the wireless network.

For example, the SIB may include a group identifier to indicate that all devices (e.g., WTRUs) that are associated with the group identifier should register with the wireless network.

For example, the SIB may include an indication that the wireless network wants any device (e.g., WTRU) that reports sensed data to register to the wireless network. Further, for example, the SIB may indicate the importance of the data that needs to be reported.

For example, the SIB may include an indication that the wireless network wants any device (e.g., WTRU) that is interested to register and avail services as a roaming WTRU in the wireless network.

For example, the SIB may include an indication that the wireless network was previously under disaster and that the disaster condition is over. Further, for example, based on this indication, the WTRU utilizing disaster roaming may return to its home PLMN (HPLMN).

For example, the SIB may include an indication of which wireless network or PLMN want the WTRU to register to it. For example, for a RAN node that is shared between multiple networks or PLMNs, the SIB message may indicate which PLMN ID that the wireless network wants the WTRU to register to it.

In some embodiments, some or all of the information of SIBx 528 is transmitted to the WTRU 502 from ng-gNB 504 in SIB1 522. In such embodiments, steps 7a 526 and 7b 528 may be skipped (e.g., because all the necessary information has already been delivered to the WTRU 502).

In some embodiments, a portion of the information specified for SIBx 528 is sent to the WTRU 502 from ng-gNB 504 in SIB1 522. In such embodiments, the remainder of the information and some additional information may be carried in SIBx 528.

In certain representative embodiments, based on the criteria indicated in the SIB (e.g., SIB1 522 and/or SIBx 528), the WTRU 502 may determine to initiate the registration request procedure (e.g., at step 8 530). In some embodiments, the WTRU 502 may apply a random delay before initiating the registration procedure to avoid simultaneous registration of many devices (e.g., WTRUs). For example, the duration of the random delay may be based on information of the SIB (e.g., SIB1 522 and/or SIBx 528).

In accordance with certain embodiments of the present disclosure, systems and methods for network-initiated registration of a WTRU in deep-sleep are described as follows.

In certain representative embodiments, a WTRU is registered with the wireless network (e.g., for normal operation) and determines to deregister from the wireless network for a certain time period (e.g., a number of hours, days, or the like). For example, the WTRU may determine to deregister from the wireless network to save power during a period where no activity is expected from the user (e.g., of the WTRU). Further, for example, the WTRU may determine to deregister from the wireless network to minimize data consumption when the user (e.g., of the WTRU) is roaming (e.g., where the WTRU expects to be awakened only when necessary).

In some embodiments, the WTRU has NIR capability. In some embodiments, a NIR-capable WTRU may have a deep-sleep and/or retired state. For example, the deep-sleep state and/or retired state may include when the WTRU is deregistered but reachable by the wireless network if needed. Further, for example, the deep-sleep state and/or retired state may be a low-power state that is different from CM_Idle and/or that is different from a sleep state associated with discontinuous reception (DRX). Moreover, for example, a WTRU in a deep-sleep state and/or a retired state may have all (e.g., simultaneous) receive/transmit (Rx/Tx) radio transmissions turned off with minimal processing activity and most system processes shut down. Also, for example, the WTRU in the deep-sleep state and/or retired state may be configured to listen to the SIB occasionally at pre-configured intervals to monitor if the wireless network triggers the WTRU for registration (e.g., NIR). Even further, for example, the WTRU in the deep-sleep state and/or retired state may perform cell selection periodically and/or camp on a cell to receive system information.

In some embodiments, the deep-sleep state and/or retired state may differ from the CM_Idle state. For example, in the deep-sleep state and/or retired state both radio resource control (RRC) and NAS connections may be disabled when the WTRU has fully deregistered. Further, for example, following WTRU deregistration associated with the deep-sleep state and/or retired state, the wireless network may not delete the contexts of the WTRU (e.g., as in the CM_Idle state). Moreover, for example, the wireless network may maintain certain information about the WTRU, as instructed by the WTRU in the deregistration message. Additionally, for example, the WTRU may also provide consent to the wireless network to keep its data for the indicated period.

FIG. 6 is a flowchart illustrating an approach for NIR of a WTRU in deep-sleep, in accordance with certain embodiments.

As shown in process 600 of FIG. 6, a WTRU 502 may deregister and enter a deep-sleep state, during which network-initiated registration of the WTRU 502 may occur. In certain representative embodiments the WTRU 502 is known to the wireless network (e.g., including at least one of 6GRAN/ng-gNB 504, 6GMM 506, UPF 508, NFs 510, UDM 512, or the like). For example, the WTRU 502 may be registered with valid subscription and have NIR capability. In some embodiments (e.g., at step 1a 604), the WTRU 502 performs capability negotiations at initial registration or during a registration update (e.g., indicating that the WTRI 502 supports NIR and/or is NIR capable).

In certain representative embodiments (e.g., at step 1b 606), the WTRU 502 determines to enter a retired state (e.g., and/or deep-sleep state) and sends deregistration request to the wireless network. For example, the WTRU 502 may include additional parameters in the deregistration request message. Further, for example, the additional parameters may include at least one of: a deep-sleep indication; an associated container including a list of preferred locations (e.g., most recent cell IDs or most often used cell IDs); user consent for the wireless network to keep user data (e.g., for a time period indicated in the consent); combinations of the same; or the like.

In some embodiments, WTRUs that indicate NIR capability during initial registration with the wireless network may create a location map of probable locations. For example, the location map may be saved in a network repository and used as preferences (e.g., by the wireless network) when initiating NIR for WTRUs.

In certain representative embodiments (e.g., at step 1c 608), the wireless network updates the WTRU state to retired (e.g., and/or deep-sleep), updates the WTRU context, and sends the deregistration accept message to the WTRU 502. For example, the WTRU 502 may perform such actions based on receiving an indication that the WTRU 502 is NIR capable and/or on receiving a deregistration message with a deep-sleep indication. Further, for example, the wireless network may update the WTRU state and/or WTRU context before or after sending the deregistration accept message to the UE. Moreover, for example, the wireless network may indicate the new WTRU state to other NFs (e.g., by sending a NF_subscription_update message to all subscribed NFs).

In certain representative embodiments (e.g., at step 2 610), the wireless network triggers NIR for the WTRU 502. For example, the wireless network may have DL data for the WTRU 502 in the retired and/or deep-sleep state (e.g., having deregistered and indicated NIR capability). Further, for example, the wireless network may determine the location of the WTRU 502 based on the preferred locations indicated by the WTRU 502 when it deregistered. Moreover, for example, the wireless network may extend the search to probable locations based on AI/ML models and historical data of the WTRU 502. Also, for example, the wireless network may trigger the network-initiated registration for the WTRU 502 based on the determined location or probable locations of the WTRU 502.

In certain representative embodiments (e.g., at step 3 612), the wireless network and/or the WTRU 502 may perform the NIR triggering procedure. For example, the wireless network and/or the WTRU 502 may perform at least one of the aforementioned steps in connection with FIG. 5. Further, for example, the wireless network may perform the step 2 516 through step 7b 528 of FIG. 5.

In certain representative embodiments (e.g., at step 4 614), the wireless network and/or the WTRU 502 may initiate the registration procedure. For example, the wireless network and/or the WTRU 502 may perform the aforementioned step 8 530 of FIG. 5.

In certain representative embodiments, a mobile network operator (MNO) of the wireless network may perform the registration and/or deregistration of the WTRU 502.

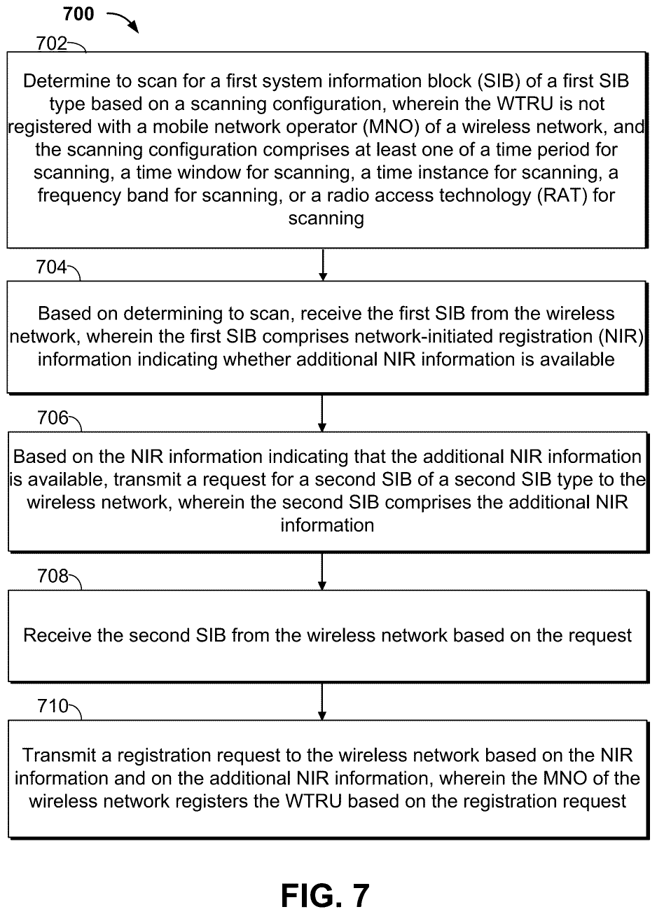

FIG. 7 is a flowchart of an illustrative method performed by a WTRU for NIR, in accordance with certain embodiments.

In certain representative embodiments, as shown in FIG. 7, a process 700 is performed by a (e.g., WTRU 102 of FIGS. 1A-D, WTRU 202 of FIGS. 2-3, WTRU 402 of FIG. 4, WTRU 502 of FIGS. 5-6) in connection with a wireless network (e.g., core network 106 and 115 of FIGS. 1A-D, RAN 104 and 113 of FIGS. 1A-D, network entities and/or NFs of FIGS. 2-6), which may be implemented in communications system 100 illustrated in FIG. 1A-1D.

At step 702, the WTRU determines to scan for a first SIB of a first SIB type based on a scanning configuration. In some embodiments, the WTRU is not registered with an MNO of a wireless network when it determines to scan for the first SIB. For example, the scanning configuration may include at least one of: a time period for scanning, a time window for scanning, a frequency band for scanning, a RAT for scanning, combinations of the same, or the like. Further, for example, the first SIB type is SIBtype1. In some embodiments, the scanning configuration is a configuration received from the wireless network or an existing configuration of the WTRU.

In some embodiments, determining to scan for the first SIB is based on at least one of: detecting a user interaction (e.g., via a GUI application of the WTRU) with the WTRU; information of the WTRU (e.g., in the deep-sleep state) stored by the wireless network; detecting a local condition of the WTRU; combinations of the same; or the like. For example, detecting a local condition of the WTRU may include detecting an environmental condition (e.g., vibrations, heat, or the like) and/or receiving an indication from a paired device via a (e.g., Bluetooth) connection between the paired device and the WTRU. In some embodiments, the WTRU may be in a deep-sleep state and may have performed one of the following: determining to enter a deep-sleep state; transmitting a deregistration request to the wireless network (e.g., including an indication that the WTRU has entered the deep-sleep state) based on determining to enter the deep-sleep state.

At step 704, the WTRU, based on determining to scan, receives the first SIB from the wireless network. In some embodiments, the first SIB includes NIR information indicating whether additional NIR information is available. In some embodiments, the wireless network transmits the first SIB to the WTRU based on at least one of: determining to perform inventory collection of WTRUs in a geographic area; determining to register roaming WTRUs within the geographic area; determining to recover WTRUs associated with a disaster condition; determining that a wireless network load in the geographic area is acceptable for registration of WTRUs; combinations of the same; or the like. In some embodiments, the NIR information includes at least one of the following: a registration type; a device type; an indication for new devices to register; an indication for previously registered devices to register; an indication for devices with previous registrations within a time period to register; registration grouping information or clustering information; a randomization parameter for registration initiation; request-specific trigger parameters or service-specific trigger parameters; combinations of the same; or the like. For example, the registration type may include at least one of: registration as a normal WTRU; registration without a PDU; registration to update location; registration associated with an application-specific location and application code; combinations of the same; or the like. In some embodiments, the first SIB is protected by at least one of: a pre-shared security association; public key cryptography; a freshness parameter; combinations of the same; or the like.

At step 706, the WTRU transmits a request for a second SIB of a second SIB type to the wireless network. In some embodiments, the second SIB includes the additional NIR information. In some embodiments, the additional NIR information includes at least one of the following: a registration type; a device type; an indication for new devices to register; an indication for previously registered devices to register; an indication for devices with previous registrations within a time period to register; registration grouping information or clustering information; a randomization parameter for registration initiation; request-specific trigger parameters or service-specific trigger parameters; combinations of the same; or the like. For example, the registration type may include at least one of: registration as a normal WTRU; registration without a PDU; registration to update location; registration associated with an application-specific location and application code; combinations of the same; or the like. In some embodiments, the WTRU transmits the request based on the NIR information indicating that the additional NIR information is available. In some embodiments, the second SIB type is a SIBtypex, where x is an integer greater than or equal to 2 (e.g., any of SIBtype2 through SIBtype21).

At step 708, the WTRU receives the second SIB from the wireless network based on the request. In some embodiments, the wireless network transmits the second SIB to the WTRU based on determining that a number of initiated WTRU registrations is less than a threshold. In some embodiments, the second SIB is protected by at least one of: a pre-shared security association; public key cryptography; a freshness parameter; combinations of the same; or the like.

At step 710, the WTRU transmits a registration request to the wireless network based on the NIR information and on the additional NIR information. In some embodiments, the wireless network registers the WTRU based on the registration request. In some embodiments, the additional NIR information includes a randomization parameter and the WTRU determines a random delay based on the randomization parameter. In some embodiments, the WTRU transmits the registration request to the wireless network based on the randomization parameter. In some embodiments, the registered WTRU may perform at least one of the following: determining to enter a deep-sleep state; transmitting a deregistration request to the wireless network (e.g., including an indication that the WTRU has entered the deep-sleep state) based on determining to enter the deep-sleep state.

In the present disclosure, “network” and “wireless network” may be used interchangeably. “WTRU”, “UE”, and “device” may also be used interchangeably herein.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience. Herein, WTRU may be used interchangeably with UE and vice versa.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

What is claimed is:

1. A method performed by a wireless transmit/receive unit (WTRU), the method comprising:
determining to scan for a first system information block (SIB) of a first SIB type based on a scanning configuration, wherein the WTRU is not registered with a mobile network operator (MNO) of a wireless network, and the scanning configuration comprises at least one of a time period for scanning, a time window for scanning, a time instance for scanning, a frequency band for scanning, or a radio access technology (RAT) for scanning;
based on determining to scan, receiving the first SIB from the wireless network, wherein the first SIB comprises network-initiated registration (NIR) information indicating whether additional NIR information is available;
based on the NIR information indicating that the additional NIR information is available, transmitting a request for a second SIB of a second SIB type to the wireless network, wherein the second SIB comprises the additional NIR information;
receiving the second SIB from the wireless network based on the request; and
transmitting a registration request to the wireless network based on the NIR information and on the additional NIR information, wherein the MNO of the wireless network registers the WTRU based on the registration request.

2. The method of claim 1, further comprising:
determining to enter a deep-sleep state; and
based on determining to enter the deep-sleep state, transmitting a deregistration request to the wireless network, wherein the deregistration request comprises an indication that the WTRU has entered the deep-sleep state.

3. The method of claim 1, wherein:
the first SIB type comprises SIBtype1; and
the second SIB type comprises SIBtypex, wherein x is an integer greater than or equal to 2.

4. The method of claim 1, wherein the scanning configuration is received from the wireless network or is an existing configuration of the WTRU.

5. The method of claim 1, wherein determining to scan for the first SIB is further based on at least one of:
detecting a local condition of the WTRU comprising at least one of an environmental condition or an indication from a paired device; or
detecting a user interaction with the WTRU.

6. The method of claim 1, wherein the wireless network transmits the first SIB to the WTRU based on at least one of:
determining to perform inventory collection of WTRUs in a geographic area;
determining to register roaming WTRUs within the geographic area;
determining to recover WTRUs associated with a disaster condition; and
determining that a wireless network load in the geographic area is acceptable for registration of WTRUs.

7. The method of claim 1, wherein at least one of the NIR information or the additional NIR information further comprises at least one of:
a registration type;
a device type;
an indication for new devices to register;
an indication for previously registered devices to register;
an indication for devices with previous registrations within a time period to register;
registration grouping information or clustering information;
a randomization parameter for registration initiation; or
request-specific trigger parameters or service-specific trigger parameters.

8. The method of claim 7, wherein the registration type comprises at least one of:
registration as a normal WTRU;
registration without a protocol data unit (PDU);
registration to update location; or registration associated with an application-specific location and application code.

9. The method of claim 7, wherein:
the additional NIR information comprises the randomization parameter;
the method further comprises determining a random delay based on the randomization parameter; and
transmitting the registration request to the wireless network is based on the random delay.

10. The method of claim 1, wherein the wireless network transmits the second SIB to the WTRU based on determining that a number of initiated WTRU registrations is less than a threshold.

11. A wireless transmit/receive unit (WTRU) comprising:
a processor; and
a transceiver coupled to the processor, wherein the WTRU is configured to:
determine to scan for a first system information block (SIB) of a first SIB type based on a scanning configuration, wherein the WTRU is not registered with a mobile network operator (MNO) of a wireless network, and the scanning configuration comprises at least one of a time period for scanning, a time window for scanning, a time instance for scanning, a frequency band for scanning, or a radio access technology (RAT) for scanning;
based on determining to scan, receive the first SIB from the wireless network, wherein the first SIB comprises network-initiated registration (NIR) information indicating whether additional NIR information is available;
based on the NIR information indicating that the additional NIR information is available, transmit a request for a second SIB of a second SIB type to the wireless network, wherein the second SIB comprises the additional NIR information;
receive the second SIB from the wireless network based on the request; and
transmit a registration request to the wireless network based on the NIR information and on the additional NIR information, wherein the MNO of the wireless network registers the WTRU based on the registration request.

12. The WTRU of claim 11, wherein the WTRU is further configured to:
determine to enter a deep-sleep state; and
based on determining to enter the deep-sleep state, transmit a deregistration request to the wireless network, wherein the deregistration request comprises an indication that the WTRU has entered the deep-sleep state.

13. The WTRU of claim 11, wherein:
the first SIB type comprises SIBtype1; and
the second SIB type comprises SIBtypex, wherein x is an integer greater than or equal to 2.

14. The WTRU of claim 11, wherein the scanning configuration is received from the wireless network or is an existing configuration of the WTRU.

15. The WTRU of claim 11, wherein the WTRU is configured to determine to scan for the first SIB further based on at least one of:
detecting a local condition of the WTRU comprising at least one of an environmental condition or an indication from a paired device; or
detecting a user interaction with the WTRU.

16. The WTRU of claim 11, wherein the wireless network transmits the first SIB to the WTRU based on at least one of:
determining to perform inventory collection of WTRUs in a geographic area;
determining to register roaming WTRUs within the geographic area;
determining to recover WTRUs associated with a disaster condition; and
determining that a wireless network load in the geographic area is acceptable for registration of WTRUs.

17. The WTRU of claim 11, wherein at least one of the NIR information or the additional NIR information further comprises at least one of:
a registration type;
a device type;
an indication for new devices to register;
an indication for previously registered devices to register;
an indication for devices with previous registrations within a time period to register;
registration grouping information or clustering information;
a randomization parameter for registration initiation; or
request-specific trigger parameters or service-specific trigger parameters.

18. The WTRU of claim 17, wherein the registration type comprises at least one of:
registration as a normal WTRU;
registration without a protocol data unit (PDU);
registration to update location; or
registration associated with an application-specific location and application code.

19. The WTRU of claim 17, wherein:
the additional NIR information comprises the randomization parameter;
the WTRU is further configured to determine a random delay based on the randomization parameter; and
the WTRU is configured to transmit the registration request to the wireless network based on the random delay.

20. The WTRU of claim 11, wherein the wireless network transmits the second SIB to the WTRU based on determining that a number of initiated WTRU registrations is less than a threshold.
